(19) United States
(12) Patent Application Publication
(10) Pub. No.: US 2024/0426615 A1
(43) Pub. Date: Dec. 26, 2024

(54) DRIVING ROUTE PREDICTION APPARATUS FOR A VEHICLE, A DRIVING ROUTE PREDICTION METHOD THEREOF, AND A SYSTEM INCLUDING THE SAME

(71) Applicants: HYUNDAI MOTOR COMPANY, Seoul (KR); KIA CORPORATION, Seoul (KR)

(72) Inventor: Sung Wook Lee, Seoul (KR)

(73) Assignees: HYUNDAI MOTOR COMPANY, Seoul (KR); KIA CORPORATION, Seoul (KR)

(21) Appl. No.: 18/384,256

(22) Filed: Oct. 26, 2023

(30) Foreign Application Priority Data
Jun. 20, 2023 (KR) 10-2023-0079110

(51) Int. Cl. G01C 21/30

(52) U.S. Cl. CPC G01C 21/30

(57) ABSTRACT

A driving route prediction apparatus, method, and system are capable of predicting a driving route using a model trained based on actual driving data. The driving route prediction apparatus for a vehicle includes a first feature extraction module configured to extract a first feature vector from vehicle driving information, a second feature extraction module configured to extract a second feature vector from driving image information, a fusion module configured to fuse the first and second feature vectors to generate fusion data, and a driving route prediction module configured to output route prediction information of the vehicle based on the fusion data.

### CROSS-REFERENCE TO THE RELATED APPLICATION

This application claims priority to Korean Patent Application No. 10-2023-0079110, filed on Jun. 20, 2023, in the Korean Intellectual Property Office, the disclosure of which is incorporated herein by reference in its entirety.

### BACKGROUND

### 1. Technical Field

The present disclosure relates to prediction of a driving route in a vehicle, and particularly relates to a driving route prediction apparatus, system, and method capable of predicting a driving route using a model trained based on actual driving data.

### 2. Description of the Related Art

Route prediction technology of an ego vehicle (i.e., a vehicle that contains sensors to perceive the environment around the vehicle, commonly applied in self-driving vehicles) is technology for detecting driving intention of a driver by utilizing sensor values such as acceleration/angular velocity of the vehicle, a steering angle, lane recognition information of a camera module, and information from a linkage system and for predicting a location of the ego vehicle at a future point. Route prediction technology provides important information in determining collision risk information with respect to a target object.

Conventional ego vehicle route prediction technology predicts future routes based on constant turn rate and acceleration (CTRA) models and constant turn rate and velocity (CTRV) models. Thus, conventional ego or self-driving vehicle route prediction technology has a problem in that there is a limit to future route prediction accuracy of a long term out of a short term and route prediction accuracy for nonlinear complex driving.

In various actual road driving situations, the driving route of the ego vehicle is largely dependent on an external driving network (for example, lane recognition information, traffic signals, crosswalks, road traffic signs, unrecognized structures, and the like). However, the conventional ego vehicle route prediction technology has a problem in that the technology cannot effectively consider such an external driving network.

In particular, even though the conventional ego vehicle route prediction technology utilizes camera recognition technology to recognize external information. The technology also performs route prediction by determining driving intention of the driver through a rule-based arbitration model. Thus, conventional ego or self-driving vehicle route prediction technology has a problem in that there is a limit to accuracy of route prediction for a condition that is not set.

This background art is technical information possessed by the inventor for derivation of the present disclosure or acquired during a derivation process of the present disclosure. This background art cannot necessarily be regarded as known art disclosed to the general public prior to filing the present disclosure.

### SUMMARY

Therefore, the present disclosure has been made in view of the above problems. It is an object of the present disclosure to provide a driving route prediction apparatus for a vehicle capable of predicting a driving route using a model trained based on actual driving data. Further objects of the present disclosure are to provide a driving route prediction method thereof and a system including the same.

It is another object of the present disclosure to provide a driving route prediction apparatus for a vehicle capable of effectively predicting a long-term complex driving route. Further objects of the present disclosure are to provide a driving route prediction method thereof and a system including the same.

It is a further object of the present disclosure to provide a driving route prediction apparatus for a vehicle capable of predicting a driving route using a model generated by learning an actual driving route based on actual road driving data. Further objects of the present disclosure are to provide a driving route prediction method thereof and a system including the same.

It is another object of the present disclosure to provide a driving route prediction apparatus for a vehicle capable of effectively predicting a driving route by reflecting various conditions in an actual road driving situation. Further objects of the present disclosure are to provide a driving route prediction method thereof and a system including the same.

It is another object of the present disclosure to provide a driving route prediction apparatus for a vehicle capable of predicting a driving route using a model generated by combining and learning driving image information and actual driving motion data based on an AI-based end-to-end (E2E) model.

The technical problems addressed by the present disclosure are not limited to the above-mentioned problems. From the following description, those of ordinary skill in the art to which the present disclosure pertains should be able to clearly understand other problems addressed by the present disclosure.

As a technical means for achieving the above-described technical task, it is possible to provide a driving route prediction apparatus for a vehicle capable of predicting a driving route using a model trained based on actual driving data, a driving route prediction method thereof, and a system including the same.

In accordance with an aspect of the present disclosure, the above and other objects can be accomplished by the provision of a driving route prediction apparatus of a vehicle. The driving route prediction apparatus includes: a first feature extraction module configured to extract a first feature vector from vehicle driving information; a second feature extraction module configured to extract a second feature vector from driving image information; a fusion module configured to fuse the first and second feature vectors to generate fusion data; and a driving route prediction module configured to output route prediction information of the vehicle based on the fusion data.

The first feature extraction module may normalize each element included in the vehicle driving information and input each normalized element into a dense layer to extract a first feature vector in a one-dimensional (1D) array.

The first feature extraction module may perform maximum-minimum normalization on lane information, an accelerator pedal control amount, a brake pedal control amount, a vehicle speed, and a wheel speed among elements included in the vehicle driving information.

The first feature extraction module may perform Gaussian distribution normalization on a vehicle dynamics model-based element among elements included in the vehicle driving information.

The vehicle dynamics model-based element may include a steering angle, a yaw rate, longitudinal acceleration, and lateral acceleration.

The second feature extraction module may extract a second feature vector in a two-dimensional (2D) array from the driving image information using a convolution neural network (CNN) and may input the second feature vector in the 2D array into a dense layer to extract a second feature vector in a 1D array.

The fusion module may concatenate the first and second feature vectors to generate a concatenation feature vector and may embed the concatenation feature vector in a preset prediction time stamp size to generate the fusion data.

The fusion module may include a neural network that uses the concatenation feature vector as an input and outputs an operation result based on a rectified linear unit (ReLU) function.

The driving route prediction module may input the fusion data to a recurrent neural network (RNN) and may input route prediction information output from the RNN to a dense layer to output route prediction information in a 1D array.

The driving route prediction module may output route prediction information including a vehicle speed vₓ, a yaw rate \dot{ψ}, an X-direction movement distance dx, a Y-direction movement distance dy, and a heading direction movement angle dθ in a form of [vₓ,\dot{ψ},dx,dy,dθ] at each preset prediction time stamp time point.

The driving route prediction module may be trained using an objective function θ* of Equation 3 for training that optimizes a driving route prediction result.

In accordance with another aspect of the present disclosure, a driving route prediction method for a vehicle is provided. The driving route prediction method includes: extracting a first feature vector from vehicle driving information; extracting a second feature vector from driving image information; fusing the first and second feature vectors to generate fusion data; and outputting vehicle route prediction information based on the fusion data.

The extracting of the first feature vector may include normalizing each element included in the vehicle driving information and may include inputting each normalized element into a dense layer to extract a first feature vector in a 1D array.

The extracting of the first feature vector may include performing maximum-minimum normalization or Gaussian distribution normalization on an element included in the vehicle driving information according to a type of element.

The extracting of the second feature vector may include extracting a second feature vector in a 2D array from the driving image information using a CNN and may include inputting the second feature vector in the 2D array into a dense layer to extract a second feature vector in a 1D array.

The generating of the fusion data may include concatenating the first and second feature vectors to generate a concatenation feature vector and may include embedding the concatenation feature vector in a preset prediction time stamp size to generate the fusion data.

The outputting of the route prediction information may include inputting the fusion data into an RNN and inputting route prediction information output from the RNN into a dense layer to output route prediction information in a 1D array.

The outputting of the route prediction information may include outputting route prediction information including a vehicle speed vₓ, a yaw rate \dot{ψ}, an X-direction movement distance dx, a Y-direction movement distance dy, and a heading direction movement angle dθ in a form of [vₓ,\dot{ψ},dx,dy,dθ] at each preset prediction time stamp time point.

The outputting of the route prediction information may be performed by a driving route prediction module trained using an objective function θ* of Equation 3 for training that optimizes a driving route prediction result.

In accordance with a further aspect of the present disclosure, a driving route prediction system for a vehicle is provided. The driving route prediction system includes: a vehicle driving information provider configured to provide vehicle driving information indicating a driving state of a vehicle; a driving image information provider configured to provide driving image information related to a front and surrounding environment of a traveling vehicle; and the driving route prediction apparatus according to embodiments of the present disclosure.

Specific details according to various examples of the present disclosure other than the means for solving the problems mentioned above are included in the description and drawings below.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a diagram illustrating a configuration of a driving route prediction system for a vehicle according to an embodiment of the present disclosure;

FIG. 2 is a diagram illustrating a configuration of a driving route prediction apparatus according to an embodiment of the present disclosure;

FIG. 3 is a diagram for describing a first feature extraction module of the driving route prediction apparatus according to an embodiment of the present disclosure;

FIG. 4 is a diagram for describing a second feature extraction module of the driving route prediction apparatus according to an embodiment of the present disclosure;

FIG. 5 is a diagram for describing a driving route prediction module of the driving route prediction apparatus according to an embodiment of the present disclosure;

FIG. 6 is a flowchart for describing a driving route prediction method according to an embodiment of the present disclosure; and

FIGS. 7A and 7B are diagrams for comparing a predicted route according to conventional driving route prediction technology with a predicted route according to driving route prediction technology of the present disclosure.

### DETAILED DESCRIPTION

The advantages and features of the present disclosure and the method for achieving the advantages and features should become apparent with reference to embodiments described below in detail in conjunction with the accompanying drawings. However, the present disclosure is not limited to the embodiments disclosed below and may be implemented in a variety of different forms. These embodiments allow the present disclosure to be complete and are provided to fully inform those of ordinary skill in the art to which the present disclosure belongs of the scope of the disclosure. Further, the present disclosure is defined by the scope of the claims.

The shapes, sizes, proportions, angles, numbers, and the like, disclosed in the drawings for describing embodiments of the present disclosure are illustrative. Thus, the present disclosure is not limited to the illustrated elements. The same reference symbol refers to the same element throughout the specification. In addition, in describing the present disclosure, when it has been determined that a detailed description of related known technologies may unnecessarily obscure the subject matter of the present disclosure, the detailed description has been omitted. When “including”, “having”, “consisting”, and the like, are used in this specification, other parts may also be present, unless “only” is used. When an element is expressed in the singular, the case including the plural is included unless explicitly stated otherwise.

In interpreting an element, the element is to be interpreted as including an error range even when there is no separate explicit description thereof.

When a temporal relationship is described with “after”, “subsequent to”, “next to”, “before”, and the like, non-consecutive cases may be included unless “immediately” or “directly” are used.

Although “first”, “second”, and the like are used to describe various elements, these elements are not limited by these terms. These terms are merely used to distinguish one element from another. Accordingly, a first element mentioned below may be a second element within the spirit of the present disclosure.

In describing the elements of the present disclosure, terms such as first, second, A, B, (a), and (b) may be used. These terms are only used to distinguish the element from other elements. The nature, sequence, order, or number of the corresponding component is not limited by the term. When an element is described as being “coupled to”, “combined with”, or “connected to” another element, the element may be directly coupled or connected to the other element. However, it should be understood that another element may be “interposed” between respective elements indirectly connected or connectable to each other unless specifically stated otherwise.

“At least one” should be understood to include all combinations of one or more associated elements. For example, “at least one of a first, second, or third element” may not only mean the first, second, or third element, but also include a combination of all elements of two or more of the first, second, and third elements.

Respective features of the various embodiments of the present specification may be partially or entirely combined or associated with each other, and various interlocking and driving are possible. Further, the respective embodiments may be implemented independently of each other or may be implemented interdependently. Also, when a component, device, element, or the like of the present disclosure is described as having a purpose or performing an operation, function, or the like, the component, device, or element should be considered herein as being “configured to” meet that purpose or to perform that operation or function.

Hereinafter, embodiments of the present disclosure are examined through the accompanying drawings and embodiments as follows. Since the scales of the components shown in the drawings are different from actual ones for convenience of description, the components are not limited to the scales shown in the drawings.

Hereinafter, a driving route prediction apparatus of a vehicle according to an embodiment of the present disclosure, a driving route prediction method thereof, and a system including the same are described with reference to the accompanying drawings.

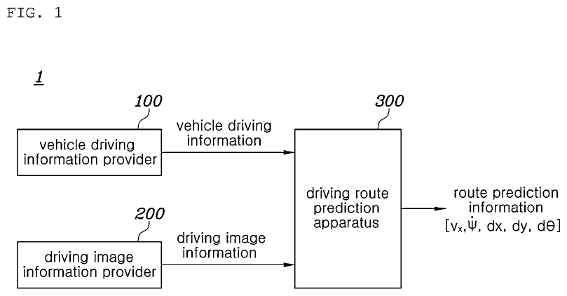

FIG. 1 is a diagram illustrating a configuration of a driving route prediction system 1 for a vehicle according to an embodiment of the present disclosure.

Referring to FIG. 1, the driving route prediction system 1 (hereinafter the system) according to an embodiment of the present disclosure is a system that may be mounted in an autonomous vehicle. The system 1 may include a vehicle driving information provider 100, a driving image information provider 200, and a driving route prediction apparatus 300. The configuration of the system 1 is not limited thereto.

The vehicle driving information provider 100 according to an embodiment may provide various types of information indicating a driving state of the vehicle (hereinafter the vehicle driving information).

For example, the vehicle driving information may include: acceleration (X direction and Y direction); angular velocity (roll rate, pitch rate, and yaw rate); steering angle; accelerator pedal control amount; brake pedal control amount; driving/wheel speed; lane information; linkage system operation information (for example, rear-wheel steering information); and the like. However, the type of vehicle driving information is not limited thereto.

In order to provide the vehicle driving information, the vehicle driving information provider 100 may include: an acceleration sensor capable of measuring lateral and/or longitudinal acceleration; an angular velocity sensor capable of measuring the angular velocity of the roll rate, the pitch rate, and/or the yaw rate; a steering angle sensor; an accelerator pedal sensor (APS); a brake pedal sensor (BPS); a vehicle speed sensor; a lane recognition sensor; and the like. However, a configuration of the vehicle driving information provider 100 is not limited thereto.

The driving image information provider 200 according to an embodiment may provide image information (hereinafter, the driving image information) related to a front and surrounding environment (driving environment) of the driving vehicle. For example, the driving image information may include surrounding objects of the traveling vehicle, such as surrounding vehicles, pedestrians, and road facilities (for example, traffic lights, road signs, traffic signs, and the like).

In order to provide the driving image information, the driving image information provider 200 may include a Light Detection and Ranging (LiDAR) sensor, a camera, a Radio Detecting and Ranging (RaDAR) sensor, an ultrasound sensor, and the like. However, a configuration of the driving image information provider 200 is not limited thereto.

The driving route prediction apparatus 300 according to an embodiment may predict the driving route of the vehicle based on the vehicle driving information from the vehicle driving information provider 100 and the driving image information from the driving image information provider 200. The apparatus 300 may also predict output route prediction information (or driving route prediction information).

According to an embodiment, the driving route prediction apparatus 300 may extract feature vectors from the vehicle driving information and the driving image information, respectively, and may generate fusion data by fusing the extracted feature vectors.

In addition, the driving route prediction apparatus 300 according to an embodiment includes a neural network model that uses fusion data as an input. Accordingly, output of the neural network model may be output as route prediction information.

According to an embodiment, the driving route prediction apparatus 300 may concatenate feature vectors and generate fusion data through an embedding process with a preset prediction time stamp size (for example, 0 to 4 sec, 0.1 sec intervals).

According to an embodiment, the driving route prediction apparatus 300 may output route prediction information at each preset prediction time stamp time point. For example, the route prediction information may include a vehicle speed vₓ, a yaw rate \dot{ψ}, an X-direction movement distance dx, a Y-direction movement distance dy, and a heading direction movement angle dθ.

According to an embodiment, the driving route prediction apparatus 300 may output route prediction information in an array form such as [vₓ,\dot{ψ},dx,dy,dθ].

In this way, the driving route prediction apparatus 300 according to an embodiment may perform training using actual road driving data as an input. The apparatus 300 may also predict the driving route of the vehicle using a neural network model, which is an end-to-end (E2E) model that directly processes input data as output data.

Therefore, the driving route prediction apparatus 300 according to an embodiment of the present disclosure may effectively predict a long-term complex driving route when compared to the conventional constant turn rate and acceleration (CTRA) model or constant turn rate and velocity (CTRV) model that predict a short-term driving route.

For example, short-term may mean a time interval of 1 second or less, and long-term may mean a time interval exceeding 1 second. In addition, the complex driving route may mean a driving route in which acceleration/deceleration and yaw rate are irregular or nonlinear.

In addition, the neural network model of the driving route prediction apparatus 300 according to an embodiment of the present disclosure may predict a driving route while being trained using, as an input, the driving image information in addition to the vehicle driving information.

The driving image information according to an embodiment may include a driving environment that has not been considered in advance. Accordingly, the driving route prediction apparatus 300 may predict a driving route by learning various driving environments that have not been considered in advance.

Therefore, the driving route prediction apparatus 300 according to an embodiment of the present disclosure may effectively predict a driving various driving environments that have not been considered in advance, in addition to predicting a route for a previously considered driving environment.

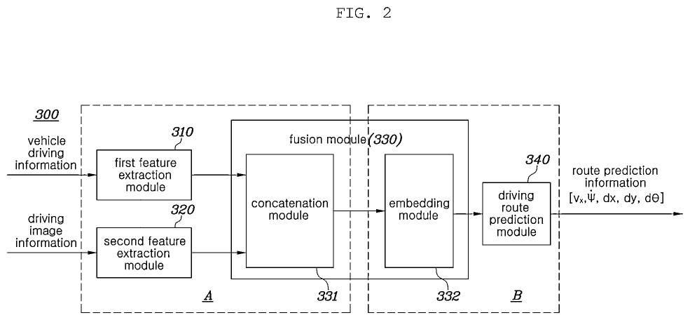

FIG. 2 is a diagram illustrating a configuration of the driving route prediction apparatus 300 according to an embodiment of the present disclosure.

Referring to FIGS. 1 and 2, the driving route prediction apparatus 300 according to an embodiment of the present disclosure may include a first feature extraction module 310, a second feature extraction module 320, a fusion module 330, and a driving route prediction module 340. The configuration of the driving route prediction apparatus 300 is not limited thereto.

The first feature extraction module 310 (or first encoder or driving information encoder) according to an embodiment may extract a feature vector (hereinafter, a first feature vector) from vehicle driving information. The module 310 may also output the extracted first feature vector to the fusion module 330.

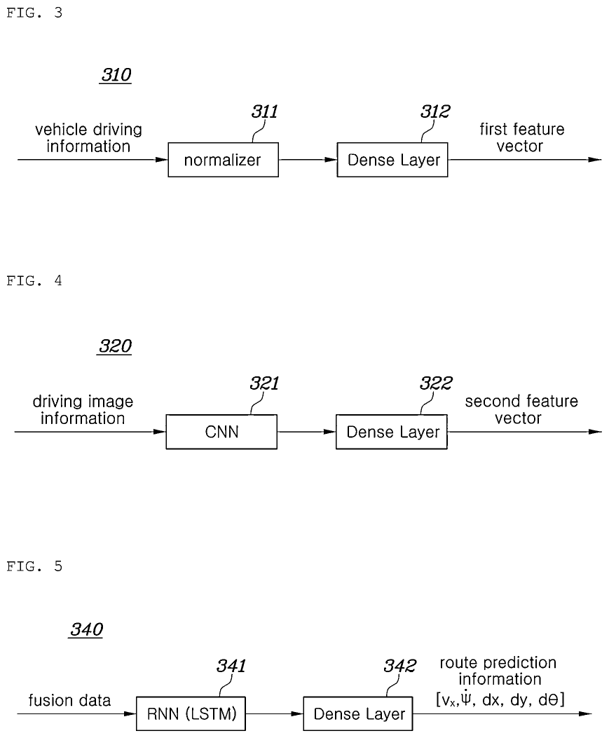

FIG. 3 is a diagram for describing the first feature extraction module 310 of the driving route prediction apparatus 300 according to an embodiment of the present disclosure.

As shown in FIG. 3, the first feature extraction module 310 is a dense layer-based encoder and may include a normalizer 311 and a dense layer 312.

The first feature extraction module 310 may normalize each element included in the vehicle driving information using the normalizer 311 and may input each normalized element to the dense layer 312 to extract a one-dimensional (1D) feature vector.

For example, elements included in the vehicle driving information may include longitudinal acceleration, lateral acceleration, angular velocity (roll rate, pitch rate, and yaw rate), steering angle, accelerator pedal control amount, brake pedal control amount, vehicle speed, wheel speed, lane information, linkage system operation information (for example, rear-wheel steering information), and the like. Elements included in the vehicle driving information are not limited thereto.

According to an embodiment, the first feature extraction module 310 (or normalizer 311) may perform maximum-minimum normalization using maximum and minimum values as parameters for lane information, accelerator pedal control amount, brake pedal control amount, vehicle speed, and wheel speed among the elements.

In addition, the first feature extraction module 310 (or normalizer 311) may perform Gaussian distribution normalization using mean and variance as parameters for a vehicle dynamics model-based element among the elements. The vehicle dynamics model-based element may be steering angle, yaw rate, longitudinal acceleration, or lateral acceleration.

Accordingly, the first feature extraction module 310 (or normalizer 311) may perform Gaussian distribution normalization for steering angle, yaw rate, longitudinal acceleration, or lateral acceleration.

The dense layer 312 is a neural network configured to output a result through an operation (Sigmoid function) as shown in Equation 1 below when an input(x) is given and is trained to update a weight(w) parameter in a direction in which an error between given data and an inferred value becomes small.

$$dense output = sigmoid ( Σ ( {w}_{j} {x}_{i} + {b}_{j} ) ) \qquad [ Equation 1 ]$$

Here, w denotes a dense layer weight, b denotes a dense layer bias, and i>j.

In addition, the dense layer 312 is a layer configured to perform a role of compressing the dimension of a given input into an output vector and extract core information. A detailed description of a general structure and operation related to the dense layer 312 has been omitted.

According to an embodiment, the dense layer 312 may use a maximum-minimum normalized element and a Gaussian distribution normalized element as learning parameters.

The second feature extraction module 320 (or second encoder or image information encoder) according to an embodiment may extract a feature vector (hereinafter referred to as a second feature vector) from the driving image information and output the extracted second feature vector to the fusion module 330.

FIG. 4 is a diagram for describing the second feature extraction module 320 of the driving route prediction apparatus 300 according to an embodiment of the present disclosure.

As shown in FIG. 4, the second feature extraction module 320 is a decoder based on and may include a convolutional neural network (CNN) 321 and a dense layer 322.

The second feature extraction module 320 may extract a second feature vector in a two-dimensional (2D) array from the driving image information using the CNN 321. The module 320 may also input the second feature vector in the 2D array to the dense layer 322 to extract a 1D second feature vector.

For example, the CNN 321, according to an embodiment, performs an encoder function. The CNN 321 may be an encoder part extracted from a CNN-based encoder-decoder structure in which an input image is restored without change by attaching symmetric CNNs on both sides.

According to an embodiment, the CNN 321 is a neural network that serves to extract key features from the driving image information. Detailed descriptions of the general structure and operation of the CNN 321 have been omitted.

As such, the second feature extraction module 320 is a neural network-based encoder that is trained based on the driving image information input in real-time while the vehicle is traveling. Thus, the second feature extraction module 320 may learn various driving environments that have not been considered in advance.

The fusion module 330 according to an embodiment may fuse the first feature vector from the first feature extraction module 310 and the second feature vector from the second feature extraction module 320 to generate fusion data. The fusion module 330 may output the generated fusion data to the driving route prediction module 340.

According to an embodiment, the fusion module 330 may include a concatenation module 331 and an embedding module 332.

The concatenation module 331 may receive input of the first feature vector output from the first feature extraction module 310 and the second feature vector output from the second feature extraction module 320. The module 331 may concatenate the first and second feature vectors and then output the concatenated vector to the embedding module 332.

Hereinafter, a feature vector in a state in which the first feature vector and the second feature vector are concatenated with each other is referred to as a “concatenated feature vector (or concatenation feature vector).”

The embedding module 332 may embed the concatenation feature vector output from the concatenation module 331 in a preset prediction time stamp size to generate fusion data. The module 332 may then output the generated fusion data to the driving route prediction module 340.

For example, the embedding module 332 may embed 41 pieces at intervals of 0.1 sec up to 4 sec. However, the present disclosure is not limited thereto.

The embedding module 332 may include a neural network configured to output a result through an operation (rectified linear unit (ReLU) function) such as Equation 2 below when an input(x) is given. Hereinafter, the neural network included in the embedding module 332 is referred to as an embedding layer.

$$embedding output = relu ( Σ ( {w}_{j} {x}_{i} + {b}_{j} ) ) \qquad [ Equation 2 ]$$

Here, x denotes an input feature, w denotes an embedding layer weight, b denotes an embedding layer bias, and i>j.

Accordingly, the embedding module 332 may be trained to update the weight(w) parameter in a direction in which the error between the given data and the inferred value becomes small. The embedding model further serves to compress the dimension of the input(x) into an output vector and fuse information of the input.

The fusion module 330 according to an embodiment may concatenate the first feature vector and the second feature vector using the concatenation module 331. The module 330 may then use the embedding module 332 to embed the concatenated feature vector in a preset prediction time stamp size, thereby generating fusion data.

The present embodiment illustrates that the fusion module 330 is configured separately from the feature extraction modules 310 and 320 and the driving route prediction module 340. However, the present disclosure is not limited thereto.

As an example, the concatenation module 331 of the fusion module 330 may be combined with the first and second feature extraction modules 310 and 320 into one module A. The embedding module 332 of the fusion module 330 may be combined with the driving route prediction module 340 into one module B.

As another example, the entire fusion module 330 may be included in the driving route prediction module 340. As still another example, the concatenation module 331 may be disposed separately from the feature extraction modules 310 and 320 and the driving route prediction module 340. The embedding module 332 may be combined with the driving route prediction module 340 into one module.

The driving route prediction module 340 (or neural network-based decoder), according to an embodiment, may receive input of fusion data output from the fusion module 330. The module 340 may generate and output route prediction information based on the received fusion data.

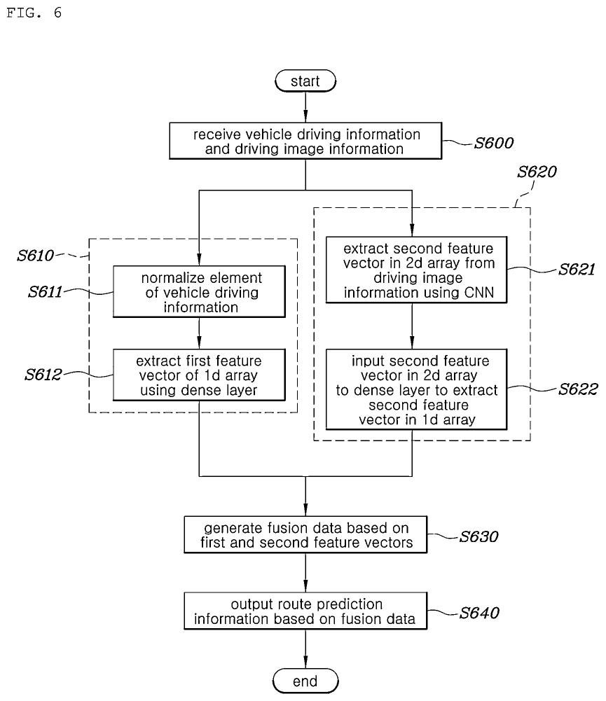

FIG. 5 is a diagram for describing the driving route prediction module 340 of the driving route prediction apparatus 300 according to an embodiment of the present disclosure.

As shown in FIG. 5, the driving route prediction module 340 may output, as route prediction information, a result output by inputting fusion data to a neural network trained based on an input.

The driving route prediction module 340 may be a decoder based on a recurrent neural network (RNN) and a dense layer. The driving route prediction model 340 may include an RNN 341 and a dense layer 342. The RNN 341 may be a long short-term memory (LSTM).

The route prediction module 340 may be expressed as an LSTM-based decoder (or LSTM decoder).

The RNN 341 may output route prediction information to the dense layer 342 based on input fusion data.

The dense layer 342 may arrange and output the route prediction information output from the RNN 341 so that the route prediction information forms an array [vₓ,\dot{ψ},dx,dy,dθ].

The driving route prediction module 340 according to an embodiment may input route prediction information, which is output by inputting fusion data to the RNN 341 to the dense layer 342 to output 1D route prediction information.

According to an embodiment, the driving route prediction module 340 may output route prediction information at each preset prediction time stamp time point.

For example, the driving route prediction module 340 may output route prediction information [vₓ,\dot{ψ},dx,dy,dθ] for each 41 time points at intervals of 0.1 sec up to 4 sec.

Further, the driving route prediction module 340 may be trained using route prediction information [vₓ,\dot{ψ},dx,dy,dθ] for each time point.

The driving route prediction module 340 may be trained using an objective function θ* for training that optimizes a driving route prediction result of the vehicle. The objective function θ* may be defined as the following Equation 3.

$${θ}^{*} = arg {max}_{θ} {\sum }_{t = 0}^{N} log P ( {S}_{t} \vert I , {S}_{0} , … , {S}_{t - 1} ; θ ) \qquad [ Equation 3 ]$$

Here, St denotes a predicted route for each time point, I denotes an input image, and θ denotes an overall neural network learning parameter.

FIG. 6 is a flowchart for describing a driving route prediction method according to an embodiment of the present disclosure.

The driving route prediction method shown in FIG. 6 may be performed by the driving route prediction system 1 described with reference to FIGS. 1-5.

Hereinafter, the driving route prediction method is described with reference to FIGS. 1-6. An operation of the driving route prediction apparatus 300 when performing driving route prediction is mainly described.

First, the driving route prediction apparatus 300 may receive vehicle driving information and driving image information (step S600).

According to an embodiment, the driving route prediction apparatus 300 may receive vehicle driving information output from the vehicle driving information provider 100 and driving image information output from the driving image information provider 200.

After step S600, the driving route prediction apparatus 300 may extract a first feature vector from the vehicle driving information (step S610) and extract a second feature vector from the driving image information (step S620).

According to an embodiment, the driving route prediction apparatus 300 may normalize each element included in the vehicle driving information using the normalizer 311 (step S611). The apparatus 300 may then input each normalized element to the dense layer 312 to extract a first feature vector in a 1D array (S612).

The dense layer 312 of the driving route prediction apparatus 300 may be trained based on input vehicle driving information and extract a first feature vector based on a trained model.

The driving route prediction apparatus 300 may perform maximum-minimum normalization using maximum and minimum values as parameters for lane information, accelerator pedal control amount, brake pedal control amount, vehicle speed, and wheel speed among elements of the vehicle driving information.

In addition, the driving route prediction apparatus 300 may perform Gaussian distribution normalization using mean and variance as parameters for a vehicle dynamics model-based element among elements of the vehicle driving information. The vehicle dynamics model-based element may be a steering angle, a yaw rate, longitudinal acceleration, or lateral acceleration.

According to an embodiment, the driving route prediction apparatus 300 may extract a second feature vector in a 2D array from the driving image information using the CNN 321 (step S621). The apparatus 300 may also input the second feature vector in the 2D array to the dense layer 322 (step S622) to extract a second feature vector in a 1D array.

The CNN 321 of the driving route prediction apparatus 300 may be trained based on input driving image information and extract a second feature vector in a 2D array based on a trained model.

The dense layer 322 of the driving route prediction apparatus 300 may be trained based on the input second feature vector in the 2D array and extract a 1D second feature vector based on a trained model.

After steps S610 and S620, the driving route prediction apparatus 300 may generate fusion data based on the first feature vector and the second feature vector (step S630).

According to an embodiment, the driving route prediction apparatus 300 may concatenate the first and second feature vectors using the concatenation module 331 (step S631). The apparatus 300 may also input the concatenated feature vector (or concatenation feature vector) to the embedding module 332 (step S632) to generate fusion data embedded in a preset prediction time stamp size.

The embedding module 332 of the driving route prediction apparatus 300 may include a neural network (embedding layer) configured to output a result through a ReLU function.

The embedding module 332 of the driving route prediction apparatus 300 may be trained based on input fusion data and may generate fusion data based on a trained model.

After step S630, the driving route prediction apparatus 300 may generate route prediction information based on fusion data (step S640).

According to an embodiment, the driving route prediction apparatus 300 may use, as input of the dense layer 342, route prediction information (including a vehicle speed vₓ, a yaw rate \dot{ψ}, an X-direction movement distance dx, a Y-direction movement distance dy, and a heading direction movement angle dθ) output by inputting fusion data to the RNN 341. Route prediction information having a 1D array form such as [vₓ,\dot{ψ},dx,dy,dθ] is thereby generated.

For example, the RNN 341 of the driving route prediction apparatus 300 may be an LSTM neural network.

The RNN 341 of the driving route prediction apparatus 300 may output route prediction information at each preset prediction time stamp time point.

The RNN 341 of the driving route prediction apparatus 300 may be trained using an objective function θ* for training that optimizes a driving route prediction result of a vehicle.

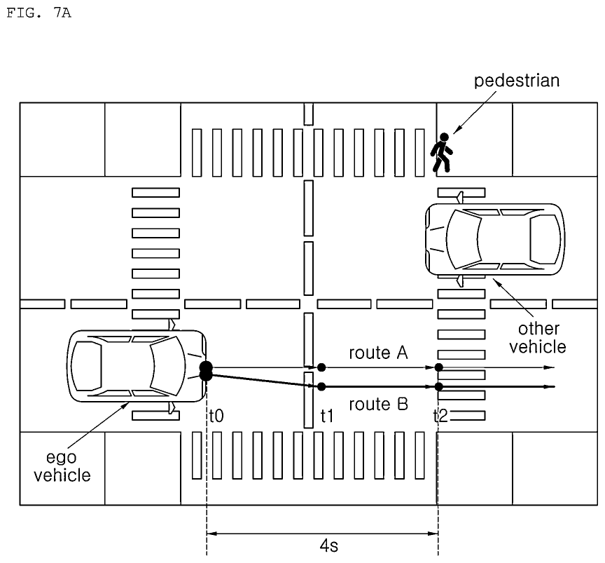

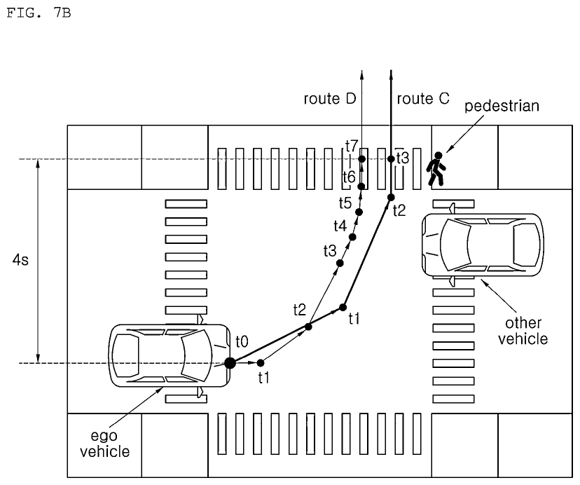

FIGS. 7A and 7B are diagrams for comparing a predicted route according to conventional driving route prediction technology with a predicted route according to driving route prediction technology of the present disclosure.

FIG. 7A is a diagram illustrating a predicted route (route A) when driving straight according to the conventional driving route prediction technology and a predicted route (route B) when driving straight according to the driving route prediction technology of the present disclosure.

Further, FIG. 7B is a diagram illustrating a predicted route (route C) when turning left according to the conventional driving route prediction technology and a predicted route (route D) when turning left according to the driving route prediction technology of the present disclosure.

In FIGS. 7A and 7B, prediction time intervals are the same as 4 seconds and a constant velocity/acceleration constant turning velocity model is used as the conventional driving route prediction technology.

Referring to FIG. 7A, both prediction according to the conventional driving route prediction technology and prediction according to the driving route prediction technology of the present disclosure are performed at two time points t1 and t2. When the ego vehicle passes through an intersection in a straight line, it can be seen that there is no significant difference in the route prediction time points (or the number of route predictions) and the predicted route in the same prediction time interval 4 seconds between the conventional technology and the technology of the present disclosure.

However, referring to FIG. 7B, it can be seen that route prediction according to the conventional technology is performed at 3 time points (t1 to t3), whereas route prediction according to the technology of the present disclosure is performed at 7 time points (t1 to t7) in the same prediction time interval.

When the ego vehicle curves (turns left) through the intersection, it can be seen that route prediction is performed at more time points (or the number of route predictions is larger) in route prediction according to the technology of the present disclosure at the same prediction time interval 4 seconds.

In addition, it can be seen that a route (route D) predicted according to the technology of the present disclosure is formed at a farther distance from the other vehicle and a pedestrian than a route (route C) predicted according to the conventional technology.

Therefore, in the case where the ego vehicle turns left through the intersection, it can be seen that route prediction according to the technology of the present disclosure is much more effective than route prediction according to the conventional technology.

According to an embodiment of the present disclosure, it is possible to provide a driving route prediction apparatus, system, and method for a vehicle capable of predicting a driving route using a model trained based on actual driving data.

Driving route prediction technology according to an embodiment of the present disclosure may predict a driving route of a vehicle using a neural network model, which is an end-to-end (E2E) model that is trained using actual road driving data as input and directly processes input data as output data.

Therefore, when the driving route prediction technology according to an embodiment of the present disclosure is used, a long-term complex driving route may be effectively predicted when compared to a conventional constant turn rate and acceleration (CTRA) model or constant turn rate and velocity (CTRV) model that predicts a short-term driving route.

In addition, the driving route prediction technology according to an embodiment of the present disclosure may perform training using driving image information in addition to vehicle driving information as input and predict a driving route.

The driving image information according to an embodiment may include a driving environment that has not been considered in advance. Accordingly, the driving route prediction technology according to an embodiment of the present disclosure may predict a driving route by learning various driving environments that have not been considered in advance.

Therefore, using the driving route prediction technology according to an embodiment of the present disclosure, it is possible to effectively predict a driving route for various driving environments that have not considered in advance in addition to predicting a route for a previously considered driving environment.

The effects of the present disclosure are not limited to the effects mentioned above. Other effects not mentioned should be clearly understood by those of ordinary skill in the art from the above description.

Since content of the problem to be solved, the means for solving the problem, and the effects mentioned above do not specify essential features of the claims, the scope of the claims is not limited by the matters described in the content of the disclosure.

Even though embodiments of the present disclosure have been described in more detail with reference to the accompanying drawings, the present disclosure is not necessarily limited to these embodiments and may be variously modified and implemented without departing from the technical spirit of the present disclosure. Therefore, embodiments disclosed herein are not intended to limit the technical spirit of the present disclosure, but to describe the technical spirit. The scope of the technical spirit of the present disclosure is not limited by these embodiments. Accordingly, it should be understood that the embodiments described above are illustrative in all respects and are not restrictive. The scope of protection of the present disclosure should be construed according to the scope of the claims, and all technical ideas within the scope equivalent thereto should be construed as being included in the scope of the present disclosure.

What is claimed is:

1. A driving route prediction apparatus for a vehicle, the driving route prediction apparatus comprising:
a first feature extraction module configured to extract a first feature vector from vehicle driving information;
a second feature extraction module configured to extract a second feature vector from driving image information;
a fusion module configured to fuse the first and second feature vectors to generate fusion data; and
a driving route prediction module configured to output route prediction information of the vehicle based on the fusion data.

2. The driving route prediction apparatus according to claim 1, wherein the first feature extraction module normalizes each element included in the vehicle driving information and inputs each normalized element into a dense layer to extract a first feature vector in a one-dimensional (1D) array.

3. The driving route prediction apparatus according to claim 2, wherein the first feature extraction module performs maximum-minimum normalization on lane information, an accelerator pedal control amount, a brake pedal control amount, a vehicle speed, and a wheel speed among elements included in the vehicle driving information.

4. The driving route prediction apparatus according to claim 2, wherein the first feature extraction module performs Gaussian distribution normalization on a vehicle dynamics model-based element among elements included in the vehicle driving information.

5. The driving route prediction apparatus according to claim 4, wherein the vehicle dynamics model-based element includes a steering angle, a yaw rate, longitudinal acceleration, and lateral acceleration.

6. The driving route prediction apparatus according to claim 1, wherein the second feature extraction module extracts a second feature vector in a two-dimensional (2D) array from the driving image information using a convolution neural network (CNN) and inputs the second feature vector in the 2D array into a dense layer to extract a second feature vector in a 1D array.

7. The driving route prediction apparatus according to claim 1, wherein the fusion module concatenates the first and second feature vectors to generate a concatenation feature vector and embeds the concatenation feature vector in a preset prediction time stamp size to generate the fusion data.

8. The driving route prediction apparatus according to claim 7, wherein the fusion module includes a neural network that uses the concatenation feature vector as an input and outputs an operation result based on a rectified linear unit (ReLU) function.

9. The driving route prediction apparatus according to claim 1, wherein the driving route prediction module inputs the fusion data into a recurrent neural network (RNN) and inputs route prediction information output from the RNN into a dense layer to output route prediction information in a 1D array.

10. The driving route prediction apparatus according to claim 1, wherein the driving route prediction module outputs route prediction information including a vehicle speed vₓ, a yaw rate \dot{ψ}, an X-direction movement distance dx, a Y-direction movement distance dy, and a heading direction movement angle dθ in a form of [vₓ,\dot{ψ},dx,dy,dθ] at each preset prediction time stamp time point.

11. The driving route prediction apparatus according to claim 1, wherein the driving route prediction module is trained using an objective function θ* for training according to the following equation that optimizes a driving route prediction result:
$${θ}^{*} = arg {max}_{θ} {\sum }_{t = 0}^{N} log P ( {S}_{t} \vert I , {S}_{0} , … , {S}_{t - 1} ; θ )$$
wherein St denotes a predicted route for each time point, I denotes an input image, and θ denotes an overall neural network learning parameter.

12. A driving route prediction method for a vehicle, the driving route prediction method comprising:
extracting a first feature vector from vehicle driving information;
extracting a second feature vector from driving image information;
fusing the first and second feature vectors to generate fusion data; and
outputting vehicle route prediction information based on the fusion data.

13. The driving route prediction method according to claim 12, wherein extracting the first feature vector comprises:
normalizing each element included in the vehicle driving information; and
inputting each normalized element to a dense layer to extract a first feature vector in a one-dimensional (1D) array.

14. The driving route prediction method according to claim 13, wherein extracting the first t feature vector comprises performing maximum-minimum normalization or Gaussian distribution normalization on an element included in the vehicle driving information according to a type of element.

15. The driving route prediction method according to claim 12, wherein extracting the second feature vector comprises:
extracting a second feature vector in a two-dimensional (2D) array from the driving image information using a convolution neural network (CNN); and
inputting the second feature vector in the 2D array to a dense layer to extract a second feature vector in a 1D array.

16. The driving route prediction method according to claim 12, wherein generating the fusion data comprises:
concatenating the first and second feature vectors to generate a concatenation feature vector; and
embedding the concatenation feature vector in a preset prediction time stamp size to generate the fusion data.

17. The driving route prediction method according to claim 12, wherein outputting the route prediction information comprises:
inputting the fusion data to a recurrent neural network (RNN); and
inputting route prediction information output from the RNN to a dense layer to output route prediction information in a 1D array.

18. The driving route prediction method according to claim 12, wherein outputting the route prediction information comprises outputting route prediction information including a vehicle speed vₓ, a yaw rate \dot{ψ}, an X-direction movement distance dx, a Y-direction movement distance dy, and a heading direction movement angle dθ in a form of [vₓ,\dot{ψ},dx,dy,dθ] at each preset prediction time stamp time point.

19. The driving route prediction method according to claim 12, wherein outputting the route prediction information is performed by a driving route prediction module trained using an objective function θ* for training according to the following equation that optimizes a driving route prediction result:
$${θ}^{*} = arg {max}_{θ} {\sum }_{t = 0}^{N} log P ( {S}_{t} \vert I , {S}_{0} , … , {S}_{t - 1} ; θ )$$
where St denotes a predicted route for each time point, I denotes an input image, and θ denotes an overall neural network learning parameter.

20. A driving route prediction system of a vehicle, the driving route prediction system comprising:
a vehicle driving information provider configured to provide vehicle driving information indicating a driving state of a vehicle;
a driving image information provider configured to provide driving image information related to a front and surrounding environment of a traveling vehicle; and
a driving route prediction apparatus,
wherein the driving route prediction apparatus includes
a first feature extraction module configured to extract a first feature vector from the vehicle driving information,
a second feature extraction module configured to extract a second feature vector from the driving image information,
a fusion module configured to fuse the first and second feature vectors to generate fusion data, and
a driving route prediction module configured to output route prediction information of the vehicle based on the fusion data.
